(19) United States
(12) Patent Application Publication
(10) Pub. No.: US 2025/0217049 A1
(43) Pub. Date: Jul. 3, 2025

(54) CONTROL CHIP AND CONTROL METHOD

(71) Applicant: Nuvoton Technology Corporation, Hsinchu Science Park (TW)

(72) Inventor: Zong-Min LIN, Kaohsiung City (TW)

(21) Appl. No.: 18/990,733

(22) Filed: Dec. 20, 2024

(30) Foreign Application Priority Data
Dec. 29, 2023 (TW) 112151469

(51) Int. Cl. G06F 3/06

(52) U.S. Cl. CPC G06F 3/0622; G06F 3/0637; G06F 3/0673

(57) ABSTRACT

A control chip is provided. A storage circuit includes a memory and a control circuit. The memory includes a first region and a second region. The first region stores command streams. The second region stores parameters. The control circuit accesses the memory. A neural-network processing unit (NPU) receives a destination block and performs a destination command stream corresponding to the destination block. In response to the destination command stream pointing to the second region, the control circuit or the NPU determines whether the destination command stream has access authority. In response to the destination command stream not having access authority, the control circuit does not read the second region. In response to the destination command stream having access authority, the control circuit reads the second region and provides the destination parameter stored in the second region to the NPU.

### CROSS REFERENCE TO RELATED APPLICATIONS

This Application claims priority of Taiwan Patent Application No. 112151469, filed on Dec. 29, 2023, the entirety of which is incorporated by reference herein.

### BACKGROUND OF THE INVENTION

### Field of the Invention

The present invention relates to a control chip, and, in particular, to a control chip comprising a neural-network processing unit (NPU).

### Description of the Related Art

Artificial neural-network model is a technology in the field of artificial intelligence. A predefined network architecture and a large number of parameters, such as weight and bias, are used to implement very complex applications, such as image recognition inference, voice recognition inference, etc. However, the command streams or parameters of neural-network models are easily stolen and used by unauthorized users.

### BRIEF SUMMARY OF THE INVENTION

In accordance with an embodiment of the disclosure, a control chip comprises a storage circuit and a neural-network processing unit (NPU). The storage circuit comprises a memory and a control circuit. The memory comprises a first region and a second region. The first region stores a plurality of command streams. The second region stores a plurality of parameters. The control circuit is configured to access the memory. The NPU receives a destination block and performs a destination command stream corresponding to the destination block. In response to the destination command stream pointing to the second region, the control circuit or the NPU determines whether the destination command stream has access authority. In response to the destination command stream not having access authority, the control circuit does not read the second region. In response to the destination command stream having access authority, the control circuit reads the second region and provides the destination parameter stored in the second region to the NPU.

A control method applied in a neural-network processing unit (NPU) and a control circuit is provided. An exemplary embodiment of the control method is described in the following paragraph. A plurality of command streams are written to a first storage region of the control circuit. A plurality of parameters are written to a second storage region of the control circuit. The NPU is triggered so that the NPU performs a destination command stream corresponding to a destination block. A determination is made as to whether the destination command stream has access authority in response to the destination command stream pointing to the second storage region. In response to the destination command stream not having access authority, the control circuit is directed to stop reading the second storage region. In response to the destination command stream having access authority, the control circuit is directed to read the second storage region and output the destination parameter.

The control method may be practiced by the systems which have hardware or firmware capable of performing particular functions and may take the form of program code embodied in a tangible media. When the program code is loaded into and executed by an electronic device, a processor, a computer or a machine, the electronic device, the processor, the computer or the machine becomes a NPU and a control circuit for practicing the disclosed method.

### BRIEF DESCRIPTION OF THE DRAWINGS

The present invention can be more fully understood by reading the subsequent detailed description and examples with references made to the accompanying drawings, wherein:

FIG. 1 is a schematic diagram of an exemplary embodiment of a control chip according to various aspects of the present disclosure.

FIG. 2 is a flowchart of a legality judgment in accordance with an embodiment of the present disclosure.

FIG. 3 is a schematic diagram of another exemplary embodiment of the control chip according to various aspects of the present disclosure.

FIG. 4 is a schematic diagram of another exemplary embodiment of the control chip according to various aspects of the present disclosure.

FIG. 5 is a flowchart of a control method in accordance with an embodiment of the present disclosure.

### DETAILED DESCRIPTION OF THE INVENTION

The present invention will be described with respect to particular embodiments and with reference to certain drawings, but the invention is not limited thereto and is only limited by the claims. The drawings described are only schematic and are non-limiting. In the drawings, the size of some of the elements may be exaggerated for illustrative purposes and not drawn to scale. The dimensions and the relative dimensions do not correspond to actual dimensions in the practice of the invention.

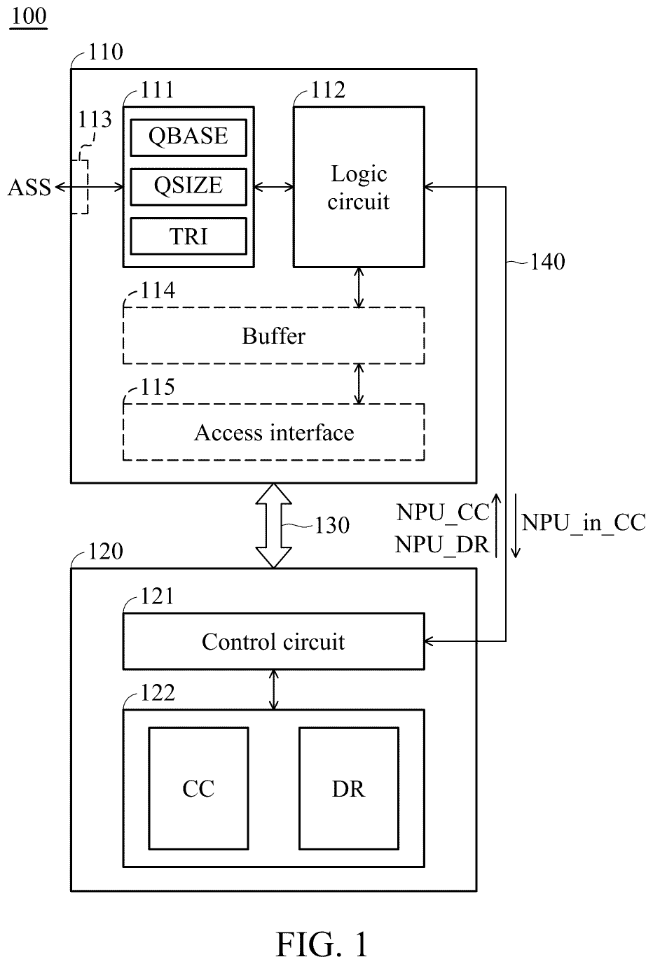

FIG. 1 is a schematic diagram of an exemplary embodiment of a control chip according to various aspects of the present disclosure. The control chip 100 comprises a neural-network processing unit (NPU) 110 and a storage circuit 120. The storage circuit 120 comprises a control circuit 121 and a memory 122. The control circuit 121 accesses the memory 122 according to the access request of the NPU 110. In one embodiment, the control circuit 121 is a controller of a flash or a resistive random-access memory (RRAM).

The memory 122 comprises regions CC and DR. The region CC stores a plurality of command streams. The region DR stores a plurality of parameters. The kind of memory 122 is not limited in the present disclosure. In one embodiment, the memory 122 is a non-volatile memory (NVM), such as a read-only memory (ROM) or a flash. In some embodiments, the command streams stores in the region CC and the parameters stored in the region DR correlate to an artificial neural-network model.

In one embodiment, the artificial neural-network model comprises a plurality of neural-network layers. Each neural-network layer is converted into an operator. For example, an artificial neural-network model may comprise a first convolution neural-network (CNN) layer, a second CNN layer, and a fully-connected (FC) layer. In such cases, the first CNN layer is converted into a first operator. The first operator comprises the operation information required by the first CNN layer. The second CNN layer is converted into a second operator. The second operator comprises the operation information required by the second CNN layer. The FC layer is converted into a third operator. The third operator comprises the operation information required by the FC layer.

The first operator operates on input data to generate first output inferenced data. The second operator operates on the first output inferenced data to generate second output inferenced data. The third operator operates on the second output inferenced data to generate third output inferenced data. The third output inferenced data is used to obtain whether the input data has images or sounds with specific properties.

In some embodiments, after the first to third operators are compiled and processed by a compiler, a series of commands and corresponding parameters can be generated. In such cases, the commands (or command streams) corresponding to the first to third operator are stored in the region CC. The parameters corresponding to the first to third operator are stored in the region DR.

The NPU 110 receives an access request ASS. The NPU 110 determines whether a destination block pointed by the access request ASS is located in the region CC. The NPU 110 provides the determination result to the storage circuit 120. The storage circuit 120 determines whether to accept the access request of the NPU 110 according to the determination result provided by the NPU 110. For example, when the access request ASS points a destination block and the destination block is not located in the region CC, the storage circuit 120 refuses the access request of the NPU 110. When the access request ASS points a destination block and the destination block is located in the region CC, the storage circuit 120 accepts the access request of the NPU 110. For example, assume that the NPU 110 sends a command access request. The storage circuit 120 reads the region CC according to the address pointed by the command access request to output a destination command stream to the NPU 110.

The NPU 110 performs the destination command stream and determines whether the destination command stream has address information. When the destination command stream has the address information, the NPU 110 determines whether the address information that the destination command stream wants to access points to the region DR. When the address information that the destination command stream wants to access does not point to the region DR, the storage circuit 120 does not read the parameters stored in the region DR. When the address information that the destination command stream wants to access points to the region DR, the NPU 110 sends a parameter access request. The storage circuit 120 reads the region DR according to the address assigned by the parameter access request to provide a destination parameter to the NPU 110.

The NPU 110 comprises a storage circuit 111 and a logic circuit 112. The storage circuit 111 stores the information pertaining to the access request ASS. In one embodiment, the access request ASS comprises the address information QBASE and the size information QSIZE. In another embodiment, the storage circuit 111 further stores the trigger information TRI. The structure of storage circuit 111 is not limited in the present disclosure. In one embodiment, the storage circuit 111 comprises a plurality of registers to store the address information QBASE, the size information QSIZE, and the trigger information TRI.

In some embodiments, the NPU 110 further comprises an access interface 113. The access interface 113 is configured to receive the address information QBASE, the size information QSIZE, and the trigger information TRI and transmit the address information QBASE, the size information QSIZE, and the trigger information TRI to the storage circuit 111. The kind of access interface 113 is not limited in the present disclosure. In one embodiment, the access interface 113 is a passive interface, such as an advanced peripheral bus interface.

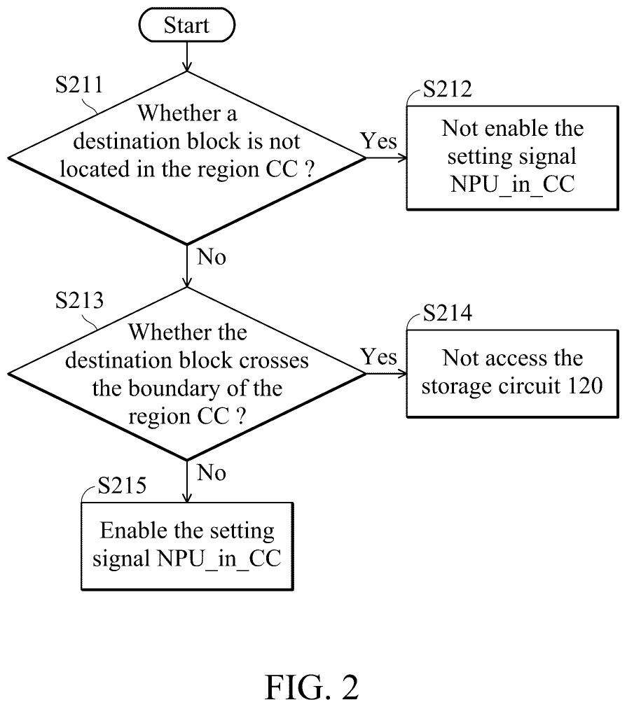

The logic circuit 112 operates according to the information stored in the storage circuit 111. For example, when the trigger information TRI is equal to a specific value (e.g., the value 1), the logic circuit 112 determines the legality of the access request ASS. FIG. 2 is a flowchart of a legality judgment in accordance with an embodiment of the present disclosure. First, the logic circuit 112 determines whether a destination block assigned by the access request ASS is not located in the region CC (step S211). When the destination block is not located in the region CC, the logic circuit 112 does not enable the setting signal NPU_in_CC (step S212). At this time, the setting signal NPU_in_CC may be at a low level. In one embodiment, when the setting signal NPU_in_CC is not enabled, it means that the access request ASS does not point to the storage circuit 120. Therefore, the storage circuit 120 does not provide the command streams and parameters stored in the storage circuit 120 to the logic circuit 112. At this time, if the access request ASS points to another storage circuit (not shown), the logic circuit 120 sends an access request to the other storage circuit so that the other storage circuit provides corresponding command streams or parameters according to the access request.

When the destination block is located in the region CC, the logic circuit 112 determines whether the destination block crosses the boundary of the region CC (step S213). In one embodiment, when a portion of the destination block is not located in the region CC, it means that the destination block crosses the boundary of the region CC. When the destination block is completely located in the region CC, it means that the destination block does not cross the boundary of the region CC.

The present disclosure does not limit how the logic circuit 112 determines whether the destination block crosses the boundary of the region CC. In some embodiments, the logic circuit 112 determines whether the destination block crosses the boundary of the region CC according to the start address and the end address of the destination block. For example, assume that the address range of region CC is 0×1000˜0×9FFF. In such cases, if the start address of the destination block is 0×0000 and the end address of the destination block is 0×2000, since the start address of the destination block exceeds the address range of the region CC, the logic circuit 112 determines that the destination block crosses the boundary of region CC. Similarly, if the start address of the destination block is 0×2000 and the end address is 0×FFFF, since the end address of the destination block exceeds the address range of the region CC, the logic circuit 112 also determines that the destination block crosses the boundary of the region CC.

When the destination block crosses the boundary of the region CC, it indicates that the access request ASS is an illegal command. Therefore, the logic circuit 112 does not access the storage circuit 120 (step S214). At this time, the storage circuit 120 does not read the command streams of the region CC and the parameters of the region DR. However, when the destination block does not cross the boundary of the region CC, it indicates that the access request ASS is a legal instruction. Therefore, the logic circuit 112 enables the setting signal NPU_in_CC (step S215). At this time, the setting signal NPU_in_CC may be at a specific level, such as a high level. The storage circuit 120 reads the command streams of the region CC and the parameters of the region DR according to the enabled setting signal NPU_in_CC.

The present disclosure does not limit how the logic circuit 112 provides the setting signal NPU_in_CC to the storage circuit 120. Refer to FIG. 1, in one embodiment, the logic circuit 112 uses a transmission path 140 to provide the setting signal NPU_in_CC to the storage circuit 120. In another embodiment, the logic circuit 112 provides the setting signal NPU_in_CC to the storage circuit 120 via the bus 130. In such cases, the bus 130 is coupled between the storage circuit 120 and the NPU 110.

No matter how the logic circuit 112 provides the setting signal NPU_in_CC to the storage circuit 120, the storage circuit 120 determines whether the NPU 110 has access authority according to the setting signal NPU_in_CC. For example, when the setting signal NPU_in_CC is at a specific level (e.g., a high level), it means that the NPU 110 has the authority to access the region DR. Therefore, the storage circuit 120 outputs the parameters of the region DR according to the access request of the logic circuit 112. When the setting signal NPU_in_CC is not at a specific level, it means that the NPU 110 does not have the authority to access the region DR. Therefore, the storage circuit 120 refuses to provide the parameters of the region DR. Since the storage circuit 120 only accepts legality access requests, the security of the parameters of the region DR can be greatly improved and data leakage can be avoided.

In other embodiments, the control circuit 121 provides the information NPU_CC of the region CC to the logic circuit 112. The logic circuit 112 determines whether the destination block assigned by the access request ASS is located in the region CC according to the information NPU_CC. When the destination block assigned by the access request ASS is located in the region CC, the logic circuit 112 enables the setting signal NPU_in_CC. When the destination block assigned by the access request ASS is not completely located in the region CC, the logic circuit 112 does not enable the setting signal NPU_in_CC.

In some embodiments, the logic circuit 112 determines whether the access request ASS has access authority. In such cases, the control circuit 121 provides the information NPU_CC of the region CC and the information NPU_DR of the region DR to the logic circuit 112. The logic circuit 112 determines whether the destination block assigned by the access request ASS is located in the region CC according to the information NPU_CC. If the destination block assigned by the access request ASS is located in the region CC, it means that the access request ASS has access authority. Therefore, the logic circuit 112 sends a command access request to instruct the control circuit 121 to read a destination command stream of the region CC. The logic circuit 112 performs the destination command stream and determines whether the destination command stream has address information.

When the destination command stream has address information, the logic circuit 112 determines whether the address information that the destination command stream wants to access points to the region DR according to the information NPU_DR. When the address information that the destination command stream wants to access points to the region DR, the logic circuit 112 sends a parameter access request to instruct the control circuit 121 to read the region CC and provides a destination parameter corresponding to the address information about the destination command stream to the logic circuit 112. In one embodiment, the control circuit 121 provides the information NPU_CC and NPU_DR to the logic circuit 112 via the transmission path 140.

In some embodiments, the control circuit 121 outputs the command streams of the region CC and the parameters of the region DR to the NPU 110 via the bus 130. Additionally, the NPU 110 sends a notification signal (not shown) via the bus 130 to notify the control circuit 121 that the current access request is sent by the NPU 110. The NPU 110 may output another notification signal (not shown) via the bus 130 to notify the control circuit 121 that the current access request is a command access request.

In some embodiments, the NPU 110 further comprises a buffer 114 and an access interface 115. The buffer 114 is configured to temporarily store data. The access interface 115 exchanges data with the storage circuit 120. For example, the access interface 115 may output a command access request to the storage circuit 120 and receive a destination command stream provided by the storage circuit 120. The buffer 114 temporarily stores the destination command stream. Then, the logic circuit 112 reads the data in the buffer 114.

Furthermore, the access interface 115 may output a parameter access request to the storage circuit 120 and receive the destination parameter provided by the storage circuit 120. The buffer 114 temporarily stores the destination parameter. Then, the logic circuit 112 reads the destination parameter of the buffer 114. The type of access interface 115 is not limited in the present disclosure. In one embodiment, the access interface 115 is an active access interface. For example, the access interface 115 is a direct memory access interface (DMA). The access interface 115 accesses the command streams and parameters from the storage circuit 120 via the bus 130.

In other embodiments, the control circuit 121 erases data in one of the regions CC and DR according to an external signal (not shown). In such cases, when the data of one of the regions CC and DR is erased, the control circuit 121 also erases the data of the other regions CC and DR. In other words, the data of regions CC and DR will be erased at the same time.

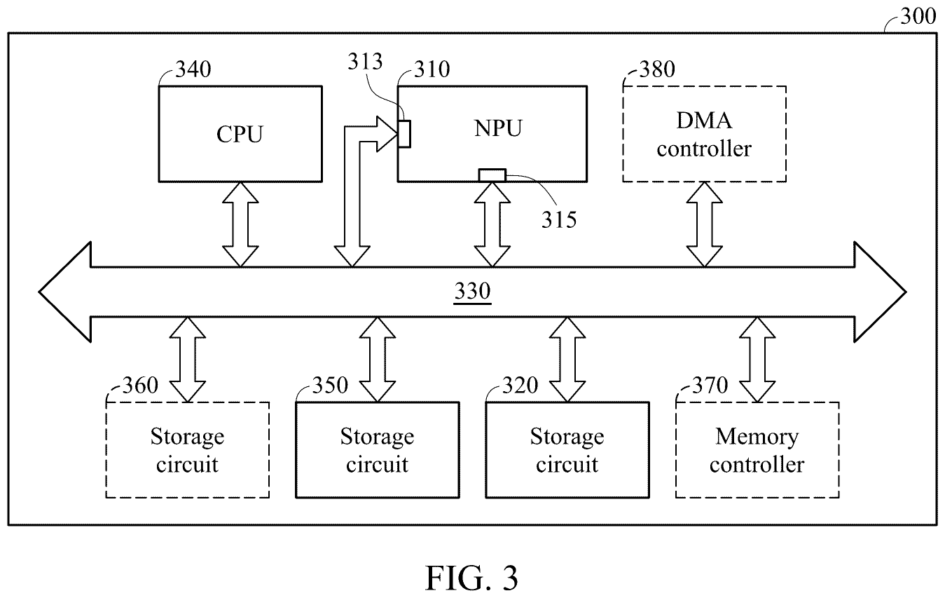

FIG. 3 is a schematic diagram of another exemplary embodiment of the control chip according to various aspects of the present disclosure. In this embodiment, the control chip 300 at least comprises a NPU 310, storage circuits 320 and 350, a bus 330, and a central processing unit (CPU) 340. Since the characteristics of the NPU 310, the storage circuits 320 and 350, and the bus 330 shown in FIG. 3 are similar to the characteristics of the NPU 110, the storage circuit 120, and the bus 130 shown in FIG. 1, the related description is omitted here.

The CPU 340 issues the access request ASS to the bus 330. The NPU 310 receives the access request ASS on the bus 330 via the access interface 313. In another embodiment, the CPU 340 provides the trigger information TRI to the bus 330. In such cases, the NPU 310 receives the trigger information TRI on the bus 330 via the access interface 313. In other embodiments, the NPU 310 further comprises an access interface 315. The access interface 315 is configured to transmit the command streams and the parameters.

In some embodiments, the CPU 340 cannot directly direct the storage circuit 320 to output the command streams and the parameters stored by itself. In such cases, since the storage circuit 320 only accepts access requests from the NPU 310, the CPU 340 needs to indirectly access the NPU 310 to read the command streams and the parameters stored in the storage circuit 320. If the CPU 340 directly issues a command access request or a parameter access request to the storage circuit 320, the storage circuit 320 ignores the access requests from the CPU 340.

In some embodiments, the CPU 340 triggers the NPU 310 via the trigger information TRI. Therefore, the CPU 340 is referred to as an active device, and the NPU 310 is referred to as a passive device. For example, when an operating voltage is stable, the CPU 340 reads and performs the program code of the storage circuit 350. When the CPU 340 performs a specific command, the CPU 340 sends the access request ASS and sets the trigger information TRI to a specific value (e.g., the value 1) to activate the NPU 310.

The kind of storage circuit 350 is not limited in the present disclosure. In one embodiment, the storage circuit 350 may be a volatile memory or a non-volatile memory. In some embodiments, the storage circuit 350 may store the input data that required by the neural-network layers and the output inferenced data generated by the neural-network layers.

In other embodiments, the control chip 300 further comprises a storage circuit 360. The feature of the storage circuit 360 is similar to the feature of the storage circuit 320. The storage circuit 360 also stores a plurality of command streams and a plurality of parameters. The security level of storage circuit 360 is lower than the security level of storage circuit 320. For example, the destination block of the access request ASS may not be located in the region CC of the storage circuit 320 but the destination block of the access request ASS may be located in the storage circuit 360. In such cases, the NPU 310 requires the storage circuit 360 to output the destination command stream. When performing the destination command stream, if the destination command stream points to the destination parameter of the storage circuit 360, the NPU 310 requires the storage circuit 360 to output the destination parameter. However, if the destination command stream points to the region DR of the storage circuit 320, the storage circuit 320 refuses to output any parameters of the region DR.

In one embodiment, the control chip 300 further comprises a memory controller 370. The memory controller 370 is configured to access the memory (not shown) which is disposed outside of the control chip 300. The CPU 340 uses the bus 330 and the memory controller 370 to access the memory disposed outside of the control chip 300. In another embodiment, the control chip 300 further comprises a DMA controller 380. In such cases, the DMA controller 380 may access the storage circuits 350 and 360.

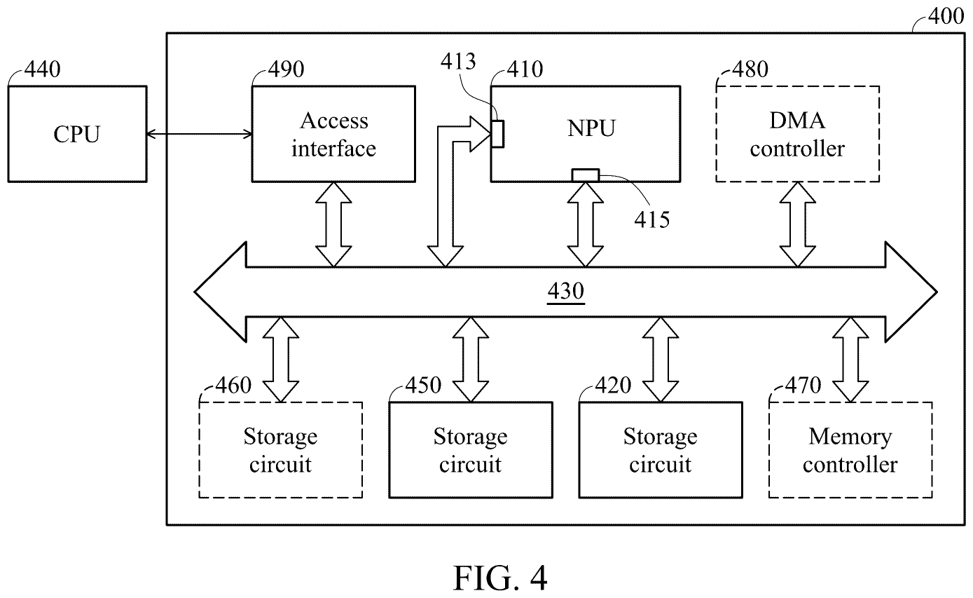

FIG. 4 is a schematic diagram of another exemplary embodiment of the control chip according to various aspects of the present disclosure. FIG. 4 is similar to FIG. 3 with the exception that the CPU 440 is independent from the control chip 400 in FIG. 4. In this embodiment, the control chip 400 further comprises an access interface 490. The access interface 490 receives the signals (e.g., the access request ASS and the trigger information TRI) from the CPU 440 and transmits the signals of the CPU 440 to the bus 440. In such cases, the NPU 410 receives the signals of the CPU 440 via the bus 430. Additionally, the access interface 490 provides the signal (e.g., the output inferenced data) of the bus to the CPU 440.

Since the characteristics of the NPU 410, the storage circuits 420, 450, and 460, the bus 430, the memory controller 470, the DMA controller 480 shown in FIG. 4 are similar to the characteristics of the NPU 310, the storage circuits 320, 350, and 360, the bus 330, the memory controller 370, the DMA controller 380 shown in FIG. 3, the related description is omitted here.

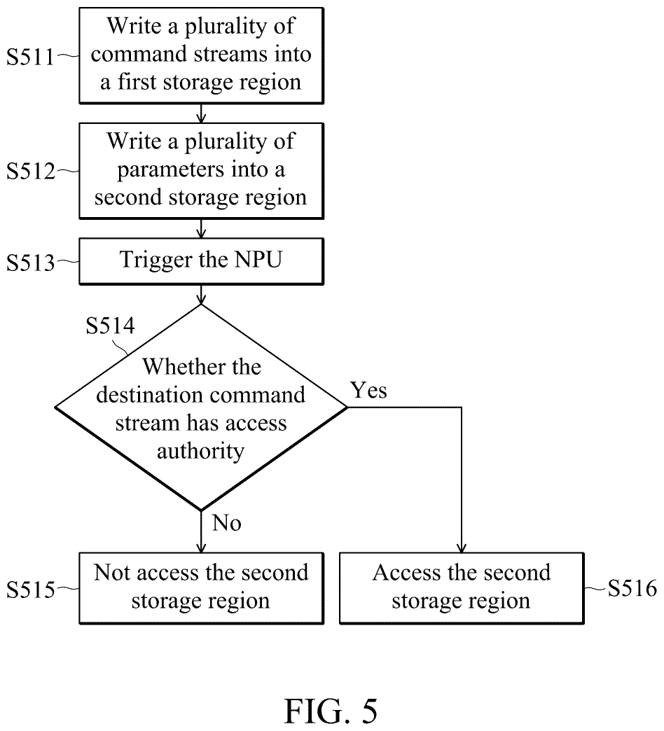

FIG. 5 is a flowchart of a control method in accordance with an embodiment of the present disclosure. The control method may take the form of a program code. When the program code is loaded into and executed by a machine, the machine thereby becomes a NPU and a control circuit for practicing the control method. First, a plurality of command streams are written into a first storage region of the control circuit (step S511). Then, a plurality of parameters are written into a second storage region of the control circuit (step S512). In some embodiments, the first and second storage regions are located in a non-volatile memory.

Next, the NPU is triggered (step S513). In one embodiment, the NPU determines whether to start operating according to the value of a register. In such cases, the value of the register may be written by a CPU. Therefore, the NPU is a passive device and controlled by the CPU (also referred to as an active device). When the value of the register is a specific value (e.g., the value 1), the NPU starts to operate. The NPU performs a destination command stream corresponding to a destination block. In one embodiment, the destination block is assigned by the CPU. In such cases, the CPU writes the information about the destination block to the NPU.

When the destination command stream points to the destination parameter of the second storage region, a determination is made as to whether the destination command stream has access authority (step S514). When the destination command stream does not have access authority, the NPU directs the control circuit not to access the second storage region (step S515). When the destination command stream has access authority, the NPU directs the control circuit to access the second storage region (step S516).

In one embodiment, the control circuit determines whether the destination command stream has access authority according to the setting signal. In such cases, the NPU first determines whether the destination block is located in the first storage region. When the destination block is located in the first storage region, it means that the destination command stream has access authority. Therefore, the NPU enables the setting signal. The control circuit accesses the second storage region according to the enabled setting signal. When the destination block is not located in the first storage region, it means that the destination command stream does not have access authority. Therefore, the NPU does not enable the setting signal so that the control circuit does not access the second storage region.

The present disclosure is not limited how the NPU determines whether the destination block is located in the first storage region. In one embodiment, the control circuit outputs the address information about the first storage region to the NPU. In such cases, the NPU compares the address information about the first storage region and the address information about the destination block. When the address information about the first storage region comprises the address information about the destination block, it means that the destination block is located in the first storage region. When the address information about the first storage region does not completely comprise the address information about the destination block, it means that the destination block is not located in the first storage region.

In another embodiment, the NPU determines whether the destination command stream has access authority according to the address information pertaining to the first storage region and the address information pertaining to the second storage region. In such cases, the control circuit outputs the address information about the first storage region and the address information about the second storage region to the NPU. The NPU compares the address information about the first storage region and the address information about the destination block. When the destination block is completely located in the first storage region, it indicates that the destination command stream has access authority. Therefore, the NPU compares the address information about the second storage region and the address information about the destination block. When the address information about the second storage region comprises the address information about the destination block, it indicates that the destination command stream has access authority so that the NPU directs the control circuit to output the parameters stored in the second storage region. However, when the destination block exceeds the first storage region, it means that the destination command stream does not have access authority. Even if the address information about the destination command stream points to the second storage region, the control circuit refuses to output the parameters of the second storage region.

In other embodiments, when the control circuit erases the data in either one of the first or second storage region, the control circuit also erases the data in the other storage regions. For example, the control circuit may erase the command streams in the first storage region according to an erase signal. In such cases, the control circuit also erases the parameters in the second storage region. Similarly, when the control circuit erases the parameters in the second storage region, the control circuit also erases the command streams in the first storage region.

It will be understood that when an element or layer is referred to as being “on”, “connected to” or “coupled to” another element or layer, it can be directly on, connected or coupled to the other element or layer or intervening elements or layers may be present. In contrast, when an element or layer is referred to as be “directly on”, “directly connected to” or “directly coupled to” another element or layer, there are no intervening elements or layers present. Additionally, “enable” shall mean changing the state of a Boolean signal.

Boolean signals may be enabled high or with a higher voltage, and Boolean signals may be enabled low or with a lower voltage, at the discretion of the circuit designer. Similarly, “disable” shall mean changing the state of the Boolean signal to a voltage level opposite the enabled state.

Control methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes a NPU and a control circuit for practicing the methods. The methods may also be embodied in the form of a program code transmitted over some transmission medium, such as electrical wiring or cabling, through fiber optics, or via any other form of transmission, wherein, when the program code is received and loaded into and executed by a machine such as a computer, the machine becomes a NPU and a control circuit for practicing the disclosed methods. When implemented on a general-purpose processor, the program code combines with the processor to provide a unique apparatus that operates analogously to application-specific logic circuits.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. It will be understood that although the terms “first,” “second,” etc. may be used herein to describe various elements, these elements should not be limited by these terms. These terms are only used to distinguish one element from another. In the following claims, the terms “first,” “second,” etc. are used merely as labels, and are not intended to impose numerical requirements on their objects.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A control chip, comprising:
a storage circuit, comprising:
a memory, comprising a first region and a second region, wherein the first region stores a plurality of command streams, and the second region stores a plurality of parameters; and
a control circuit configured to access the memory; and
a neural-network processing unit (NPU) receiving a destination block and performing a destination command stream corresponding to the destination block,
wherein:
in response to the destination command stream pointing to the second region, the control circuit or the NPU determines whether the destination command stream has access authority,
in response to the destination command stream not having access authority, the control circuit does not read the second region,
in response to the destination command stream having access authority, the control circuit reads the second region and provides a destination parameter stored in the second region to the NPU.

2. The control chip as claimed in claim 1, further comprising:
a bus coupled between the storage circuit and the NPU; and
a transmission path independent from the bus.

3. The control chip as claimed in claim 2, wherein:
the control circuit determines whether the destination command stream has access authority according to a setting signal;
in response to the setting signal being at a specific level, it indicates that the destination command stream has access authority, and
in response to the setting signal not being at the specific level, it indicates that the destination command stream does not have access authority.

4. The control chip as claimed in claim 3, wherein:
the NPU determines whether the destination block is located in the first region, and
in response to the destination block being located in the first region, the NPU sets the setting signal so that the setting signal is at the specific level, and
in response to the destination block not being located in the first region, the NPU sets the setting signal so that the setting signal is not at the specific level.

5. The control chip as claimed in claim 4, wherein the NPU sends the setting signal to the control circuit via the bus.

6. The control chip as claimed in claim 4, wherein the NPU sends the setting signal to the control circuit via the transmission path.

7. The control chip as claimed in claim 2, wherein the control circuit provides information about the first and second regions to the NPU via the transmission path, and the NPU determines whether the destination command stream has access authority according to the information about the first and second regions.

8. The control chip as claimed in claim 7, wherein:
in response to the destination block being in the first region, the NPU sends a command access request to instruct the control circuit to read the destination command stream from the first region,
the NPU performs the destination command stream and determines whether the destination command stream points to the second region according to address information about the second region,
in response to the destination command stream pointing to the second region, the NPU sends a parameter access request for the control circuit to provide the destination parameter.

9. The control chip as claimed in claim 7, wherein in response to a portion of the destination block not being located in the first region, the control circuit refuses to read the second region.

10. The control chip as claimed in claim 7, wherein the NPU comprises:
a direct memory access interface configured to access commands and parameters from the bus.

11. The control chip as claimed in claim 1, wherein in response to the destination block being completely located in the first region and the destination command stream pointing to the second region, the control circuit provides the destination parameter to the NPU.

12. The control chip as claimed in claim 1, further comprising:
a central processing unit (CPU) providing the destination block,
wherein the CPU drives the NPU so that the NPU performs the destination command stream corresponding to the destination block.

13. The control chip as claimed in claim 12, wherein the NPU comprises:
a first access interface configured to receive the destination block;
a second access interface configured to receive the destination parameter;
a first register configured to store the destination block;
a second register storing trigger information; and
a logic circuit determining whether to perform the destination command stream corresponding to the destination block according to the trigger information,
wherein the CPU provides the trigger information.

14. The control chip as claimed in claim 1, wherein the memory is a read-only memory.

15. The control chip as claimed in claim 14, wherein in response to the control circuit erasing one of the command streams stored in the first region and the parameters stored in the second region, the control circuit erases the other command streams stored in the first region and the parameters stored in the second region.

16. A control method applied in a neural-network processing unit (NPU) and a control circuit, comprising:
writing a plurality of command streams to a first storage region of the control circuit;
writing a plurality of parameters to a second storage region of the control circuit;
triggering the NPU so that the NPU performs a destination command stream corresponding to a destination block;
determining whether the destination command stream has access authority in response to the destination command stream pointing to the second storage region;
directing the control circuit to stop reading the second storage region in response to the destination command stream not having access authority; and
directing the control circuit to read the second storage region and output a destination parameter in response to the destination command stream having access authority.

17. The control method as claimed in claim 16, wherein the step of determining whether the destination command stream has access authority comprises:
determining whether the destination block is located in the first storage region,
wherein:
in response to determining that the destination block is located in the first storage region, this means that the destination command stream has access authority, and
in response to determining that the destination block is not located in the first storage region, this means that the destination command stream does not have access authority.

18. The control method as claimed in claim 17, further comprising:
directing the control circuit to output address information pertaining to the first storage region; and
comparing the address information pertaining to the first storage region and address information pertaining to the destination block,
wherein:
in response to the address information pertaining to the first storage region comprising the address information pertaining to the destination block, this means that the destination block is located in the first storage region,
in response to the address information pertaining to the first storage region not completely comprising the address information pertaining to the destination block, this means that the destination block is not located in the first storage region.

19. The control method as claimed in claim 18, further comprising:
directing the control circuit to output address information about the second storage region; and
comparing the address information about the second storage region and address information about the destination command stream in response to the address information about the first storage region comprising the address information about the destination block,
wherein:
in response to the address information about the second storage region comprising the address information about the destination command stream, this means that the destination command stream has access authority,
in response to the address information about the second storage region not comprising the address information about the destination command stream, this means that the destination command stream does not have access authority.

20. The control method as claimed in claim 16, wherein in response to either of the first or second storage regions being erased by the control circuit, the control circuit erases the other of the first and second storage regions.
